(19) United States
(12) Patent Application Publication
(10) Pub. No.: US 2008/0107014 A1
(43) Pub. Date: May 8, 2008

(54) Distributed Wireless System with Centralized Control of Resources

(75) Inventors: Xiaoqing Huang, Guangdong (CN); Sheng Liu, Guangdong (CN); Baijun Zhao, Guangdong (CN)

Correspondence Address: SENNIGER POWERS LLP, ONE METROPOLITAN SQUARE, 16TH FLOOR, ST LOUIS, MO, 63102, US

(73) Assignee: Utstarcom Telecom Co., Ltd., Hangzhou City, (CN)

(21) Appl. No.: 11/568,180

(22) PCT Filed: Apr. 22, 2004
(86) PCT No.: PCT/CN04/00387

§ 371 Date: Aug. 14, 2007

(51) Int. Cl. H04L 12/24; H04Q 7/20

(52) U.S. Cl. 370/216; 370/329; 370/336

(57) ABSTRACT

The present invention provides a distributed wireless system with centralized control of resources, comprising: a plurality of communication processing devices connected to each other, each communication processing device performing the channel processing task of cells which it is responsible for, including processing an uplink wireless signal into an uplink data frame, and processing a downlink data frame into a downlink wireless signal; and a system control device connected to said communication processing devices and a network control device, comprising channel processing scheduling means for controlling the allocation of channel processing tasks among said communication processing devices, so that channel processing tasks of cells which one of the communication processing devices is responsible for are partly or wholly allocated to other channel processing devices for processing, and routing means for routing and transmitting data between the network control device network control device and a radio gateway.

### TECHNICAL FIELD

The present invention relates to the field of a wireless access network in a mobile communication system, and in particular relates to a distributed wireless system with centralized control of channel processing resources.

### BACKGROUND TECHNOLOGY

As shown in FIG. 1a, a base station (BTS) performs transmission, reception and processing of wireless signals, and a conventional BTS is mainly composed by a baseband processing subsystem, a radio frequency (RF) subsystem and antennas, and one BTS may cover different cells through a plurality of antennas, And as shown in FIG. 1b, each BTS connects to the base station controller (BSC) or wireless networks controller (RNC) respectively through a certain interface.

In the traditional base station system as shown in FIG. 1a, since the respective baseband processing subsystem, RF subsystem and antenna in each cell are geographically located together, therefore each cell must be equipped with enough channel processing resources to fulfill each cell's peak traffic, and therefore needs a higher cost. To solve this problem, there is proposed centralized base station system based on remote antenna units, that is, a base station structure with a low cost as shown in FIG. 2, and more implementation details were disclosed in PCT patent WO9005432 “Communications system”, U.S. Pat. No. 5,657,374 “Cellular system with centralized base stations and distributed antenna units”, U.S. Pat. No. 6,324,391 “Cellular communication with centralized control and signal processing”, China patent CN96116888 “duplex open air base station transceiver subsystem using a hybrid system”, and United States Patent application US20030171118 “Cellular radio transmission apparatus and cellular radio transmission method”.

As shown in FIG. 2, existing centralized BTS system 10 based on remote antenna units is composed of a central channel processing subsystem 11 and remote antenna units 15 which are installed centralizedly. The central channel processing subsystem 11 mainly comprises channel processing resource pool 12, signal distribution unit 13, and line interface unit 14, wherein the channel processing resource pool 12 is formed by stacking a plurality of channel processing units, and performs tasks such as baseband signal processing of cells possessed by the BTS, and the signal distribution unit 13 dynamically allocates channel processing resources according to conditions of actually active users of different cells to realize effective sharing of the processing resources among multiple cells. The remote antenna unit 15 is mainly constituted by the transmission channel's radio frequency power amplifier, the reception channel's low noise amplifier, antennas and etc. The link between the central channel processing subsystem 11 and the remote antenna unit 15 may adopt transmission medium such as optical fiber, coaxial cable, microwave and etc.; the signal transmission may be done by way of digital signals after sampling, or analog signals after modulating; The signals may be baseband signals, intermediate frequency signals or radio-frequency signals. For technologies for dynamically allocating channel processing resources, please refer to U.S. Pat. No. 6,353,600 “Dynamic sectorization in CDMA employing centralized base-station architecture”, U.S. Pat. No. 6,594,496 “Adaptive capacity management in a centralized base station architecture” and etc.

Although the centralized base station system based on remote antenna units has the advantage of resource sharing, for fully exploiting the benefit of channel processing resource centralization, it is usually needed to put as much as possible of cells under the centralized control, thereby producing the following problems: one problem is that as the cost in transmission link increases, those cells geographically located farther away need to be connected the central channel processing subsystem through wideband links such as optical fiber and etc., thereby increasing the cost of transmission links; another problem is the reduced reliability of the system because once the central channel processing subsystem fails, a large amount of cells cannot provide services. Although increasing resource redundancy of the central channel processing subsystem may reduce the impact of this negative factor, this in turn counteracts the advantage of lower cost because of resource sharing in the centralized base station system based on remote antenna units.

### SUMMARY OF THE INVENTION

An object of the present invention is to provide a distributed wireless system with centralized control of channel processing resources, which permits to reserve the advantage of resource sharing in the centralized base station based on remote antenna units, and to overcome the above potential problem.

The present invention provides a distributed wireless system with centralized control of resources, comprising: a plurality of communication processing devices connected to each other, each communication processing device performing the channel processing task of cells which it is responsible for, including processing an uplink wireless signal into an uplink data frame, and processing a downlink data frame into a downlink wireless signals and a system control device connected to said communication processing devices and a network control device, comprising channel processing scheduling means for controlling the allocation of channel processing tasks among said communication processing devices, so that channel processing tasks of cells which one of the communication processing devices is responsible for are partly or wholly allocated to other channel processing devices for processing, and routing means for routing and transmitting data between the network control device network control device and a radio gateway.

The present invention also provides a distributed wireless system with centralized control of resources, comprising: a plurality of communication processing devices connected to each other, each communication processing device performing the channel processing task of cells which it is responsible for, including processing an uplink wireless signal into an uplink data frame, and processing a downlink data frame into a downlink wireless signal, and directly connected to a network control device to exchange data; and a system control device connected to said communication processing devices and the network control device, comprising channel processing scheduling means for controlling the allocation of channel processing tasks among said communication processing devices, so that channel processing tasks of cells which one of the communication processing devices is responsible for are partly or wholly allocated to other channel processing devices for processing.

As compared to the prior art, in case of serving the same number of cells, the present invention needs less transmission resources and guarantees that the entire wireless system has higher usability. Accordingly, since the cost of transmission resources of the cells is reduced, it is possible to accommodate more cells, so that the total channel processing resources of the entire distributed wireless system are more than a conventional centralized base station, thereby obtaining higher statistical multiplexing gain. The high usability guarantees that in the same call loss condition, the average channel processing resource cost per cell of the entire wireless system is smaller.

### DESCRIPTION OF THE DRAWINGS

The above and/or other aspects, features and/or advantages of the present invention will be more completely appreciated in view of the following description in conjunction with the accompanying figures, wherein;

FIG. 1a is a schematic diagram showing the structure of a conventional BTS;

FIG. 1b is a schematic diagram showing the structure of a network including conventional BTSs and a BSC/RNC;

FIG. 2 shown a structure of a centralized base station using remote antenna units;

FIG. 3 shows one embodiment of the distributed wireless system with centralized control of channel processing resources according to the present invention;

FIG. 4 shows another embodiment of the distributed wireless system with centralized control of channel processing resources according to the prevent invention;

FIG. 5 shows the functional structure of radio control and routing gateway of the distributed wireless system according to the present invention;

FIG. 6 shows the functional structure of radio gateway controller of the distributed wireless system according to the present invention;

FIG. 7 is a schematic diagram showing the structure of a radio gateway of the distributed wireless system according to the present invention; And

FIGS. 8a and 8b show two signal distribution manners of the distributed wireless system according to the present invention.

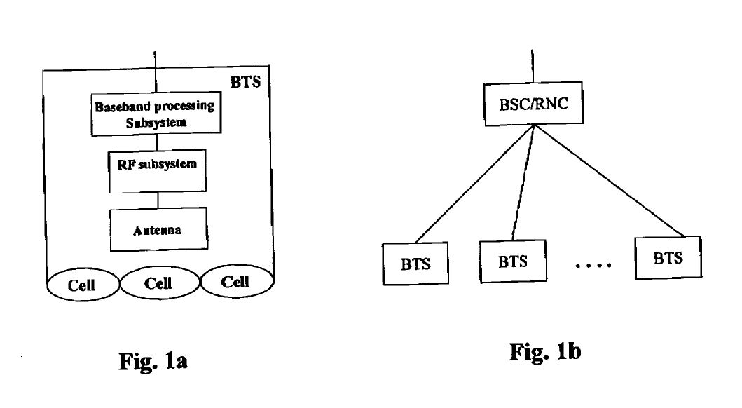

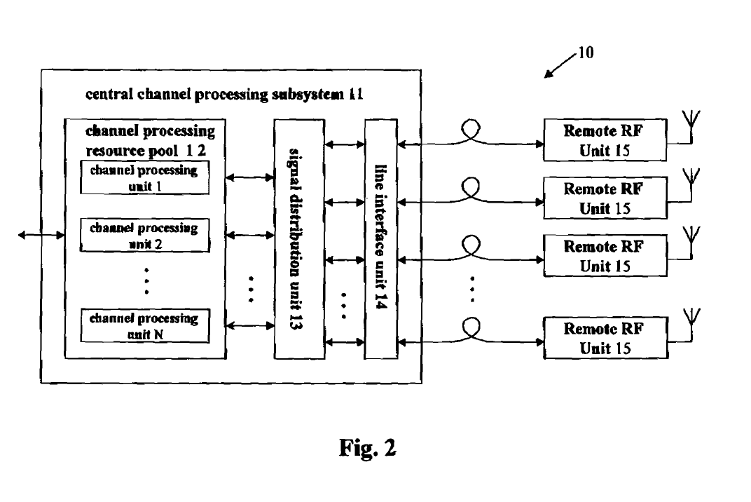

### DETAILED DESCRIPTION OF THE PREFERRED EMBODIMENTS

The embodiment of the present invention is now described by referring to the drawings.

### First Embodiment

1. System Architecture

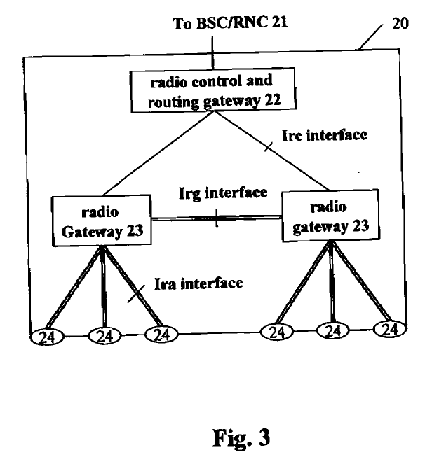

FIG. 3 shows one embodiment of the distributed wireless system with centralized control of channel processing resources according to the present invention. As shown in FIG. 3, a distributed wireless system 20 based on centralized control of channel processing resources comprises a radio control and routing gateway 22, radio gateways (Radio Gateway—RG) 23 and remote antenna units (RAU) 24. The radio gateway 23 performs processing of uplink and down ink wireless signals, and the processing is similar to the processing of the channel processing unit in a centralized base station system. The radio gateway 23 connects to the remote antenna units (RAU) 24 through interfaces Ira. The distributed wireless system 20 includes a plurality of radio gateways 23, and there are interfaces Irg between them. Each radio gateway 23 connects to the radio control and routing gateway (Radio Control and Routing Gateway—RCRG) 22 through an interface Irc.

According to the present embodiment, the interface Ira between the radio gateway 23 and the remote antenna unit 24 may be the interface between the central channel processing subsystem and the remote antenna unit in the existing centralized base station system, which may employ transmission medium such as optical fiber, coaxial cable, microwave and etc. The signal transmission may be done by way of digital signals after sampling, or analog signals after modulating. The signals may be baseband signals, intermediate frequency signals or radio-frequency signals. In the present invention, however, it is preferable to employ the baseband digital signal formed by I/Q (in phase/quadrature) components to perform the transmission. This is because, to perform a corresponding control and management to the remote antenna unit, besides the processing of wireless signal transmission, the interface Ira further needs to perform a simultaneous transmission of other control and management information, and the digital transmission facilitates to perform a simultaneous transmission of the above data using the unified physical links.

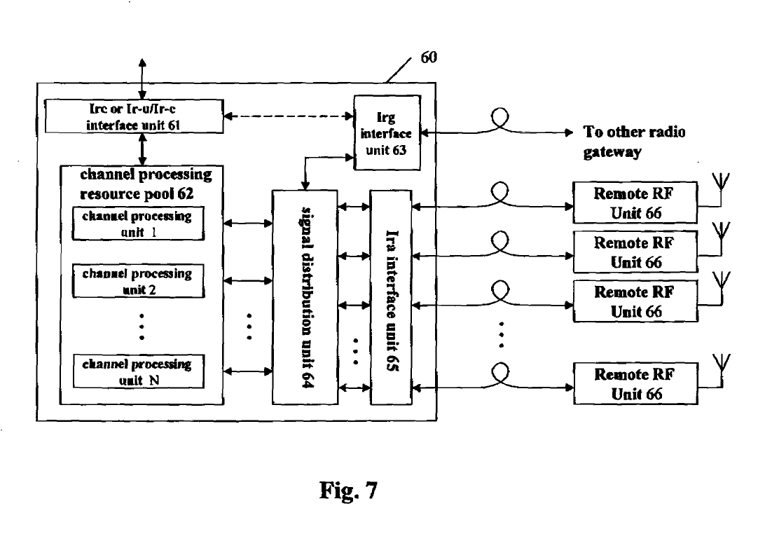

FIG. 7 is a schematic diagram showing the structure of a radio gateway 60 of the distributed wireless system according to the present invention. As shown in FIG. 7, a radio gateway 60 mainly comprises functional units including a channel processing resource pool 62, a signal distribution unit 64, an Ira interface unit 65, an Irg interface unit 63, an Irc interface unit 61 and etc. In the embodiment as shown in FIG. 3, there is a direct or indirect path as shown by the dashed line between the Irg interface unit 63 and the Irc interface unit 61.

According to the present embodiment, the radio gateway 23 is mainly formed by channel processing units for performing baseband processing of wireless signals. By taking a WCDMA wideband code division multiple access) system as example, in the downlink direction, the radio gateway receives downlink data frames of transmission channels from the Irc, and performs operations including channel encoding, interleaving, rate adaption, spreading, scrambling, modulating, waveform shaping filtering and etc.; in the uplink direction, the radio gateway receives I/Q baseband digital signals from the Ira or Irg interface, performs operations including matching filtering, despreading, channel estimation, RAKE merging, signal-interference ratio (SIR) estimation, de-interleaving, channel decoding and etc., and forms uplink data frames of the transmission channel. In addition, the radio gateway further performs operations such an inner-loop power control, random access control and etc.

The interface Irg between the radio gateways in a new interface proposed by the present invention, and plays an important role in the distributed channel processing of the present invention. According to the present invention, a radio gateway connected to the remote antenna units of a cell through the Ira interface is called as a serving radio gateway (Serving RG—SRG), and a radio gateway for sharing a part or all of channel processing of the cell through the Irg interface is called as a drift radio gateway (Drift RG—DRG). According to the present invention, the Irg interface mainly transmits uplink baseband digital wireless signals formed by I/Q component delivered to the drift radio gateway via the serving radio gateway, and downlink baseband digital wireless signals formed by I/Q components delivered to the serving radio gateway via the drift radio gateway.

In the distributed wireless system an shown in FIG. 3, the interface Irc between the radio control and routing gateway 22 and the radio gateway 23 is divided into a control plane and a user plane. The control plane is used for transferring control signaling of the radio control and routing gateway 22 with respect to the radio gateway 23 which it in responsible for. The control signaling includes two classes, i.e. operations for configuration and modification of controlling parameters of the channel processing units within the radio gateway according to configuration state of physical channels of the underling cells, for purpose of allocating physical channels of physical channels among the channel processing units, and operations including allocation control, establishment, modification, relearning and etc. of channel processing resources among the radio gateways, for purpose of controlling the drift radio gateway to share channel processing tasks of the serving radio gateway; the user plane transmits uplink and downlink data frames of the transmission channels corresponding allocation condition of channel processing resources for the radio gateways. In addition, the control plane or user plane should further comprise timing control information of the cells, and taking a WCDMA system for example, said timing control information of the cells is frame timing information of BFN or/and SFN.

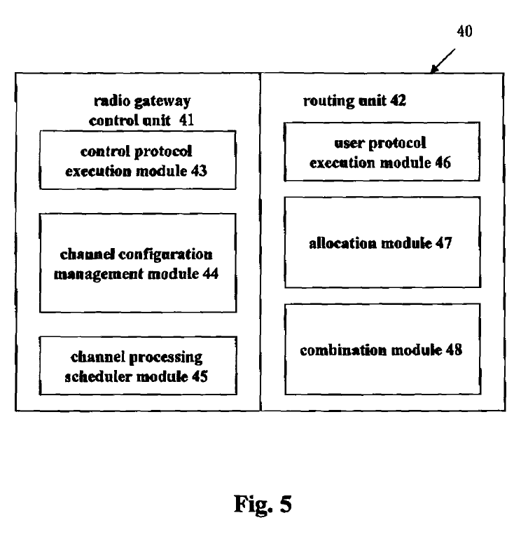

FIG. 5 shows a functional structure 40 of the radio control and routing gateway 22 in the distributed wireless system of FIG. 3, wherein for concision and clarity of explanation, the illustration of modules unrelated to the present invention are omitted, because these modules are known for one skilled in the art. As shown in FIG. 5, the structure 40 comprises a radio gateway control unit 41 and a routing unit 42. The radio gateway control unit 41 comprises a control protocol execution module 43, a channel configuration management module 44 and a channel processing scheduler module 45. The routing unit 42 comprises a user protocol execution module 46, an allocation module 47 and a combination module 48. The control protocol execution module 43 is used for implementing a functional entity of interface control plane between the BTS and the BSC/RNC, so that the BSC/RNC may enforce control to the radio gateway through the control protocol execution module 43. By taking a WCDMA system as example, the module implements a functional entity of interface protocol NBAP (node B application protocol) between the BTS (i.e. Node B) and the RNC. The channel configuration management module 44 is in charge of managing channel configuration of the radio gateways, so that the BSC/RNC may enforce control to the channel configuration of the radio gateways through the channel configuration management module 44. For example, through the channel configuration management module 44, it is possible to map the configuration and management of physical channels by the interface control plane protocol between the BTS and the BSC/RNC into operations such an configuration and modification of control parameters for channel processing units in the radio gateways. The channel processing scheduler module 45 is in charge of overall scheduling of channel processing resources of the radio gateways which it is responsible for, i.e., implementing optimized allocation and control of the channel processing resources of the radio gateways according to actual traffic distribution of the cells, and performing operation such an establishment, modification and releasing of corresponding channel processing resources. The routing unit 42 is in charge of user plane data frame routing. Its user protocol execution module 46 is used for implementing a functional entity of interface user plane between the BTS and the BSC/RNC, in order to transfer uplink and downlink data frames between the BSC/RNC and the radio gateway. By taking a WCDMA system as example, the module implements a functional entity of frame protocol for the user plane common transmission channel and the dedicated transmission channel between the Node B and the RNC. In the downlink direction, the allocation module 47 performs separating or multicasting for the downlink data frames from the BSC/RNC according to allocation condition of channel processing resources of the radio gateways, and routes them to corresponding radio gateways. In the uplink direction, the combination module 48 performs merging for the uplink data frames as formed by processing from the BSC/RNC according to allocation condition of channel processing resources of the radio gateways, and transmits them to the BSC/RNC through the interface between the BTS and the BSC/RNC. In addition, the structure 40 further comprises a timing control module (not shown) of the entire distributed wireless system.

According to the above, in the distributed wireless system as shown in FIG. 3, the radio control and routing gateway 22 will terminate the interface protocol of control plane and user plane between the BTS and the BSC/RNC 21, and provide a unified interface with the BSC/RNC 21.

It is to be noted that, in the embodiment as shown in FIG. 5, the control protocol execution module 43 and the channel configuration management module 44 are optional. Without these two modules, it is also possible to achieve the object of the present invention.

2. Resource Control and Signal Distribution

As noted earlier, the radio control and routing gateway 22 is in charge of optimized allocation and control of channel processing resource of the radio gateways 23. According to the present invention, in the configuration of network when networking, the remote antenna units corresponding to a certain number of cells geographically adjacent are connected to a radio gateway through the above Ira interface. Thus, when satisfying a certain conditions, for example, when total traffic of the cells belonging to a radio gateway is below a certain threshold, all the channel processing may be performed by the radio gateway. When satisfying another condition, for example, when the total traffic of cells belonging to the radio gateway is above the threshold or other threshold, or when the radio gateway partly or entirely fails, the radio control and routing gateway 22 will, based on the load of other radio gateway having an Irg interface with the radio gateway, allocate the channel processing load beyond the radio gateway's processing capacity to other radio gateway satisfying the processing demand, i.e., transmitting relevant wireless signals to the relevant radio gateway through the Irg interface in order to perform corresponding channel processing by it.

Since there is a certain connection between the uplink and downlink signals, for example in the WCDMA system, uplink and downlink physical channels satisfy a certain timing relation, and the generation and processing of some control commands of the physical layer, such as power control command (TPC), feedback indication (FBI) in the closed loop transmission diversity and site selection diversity transmission (SSDT), and etc., the present invention preferably requires that the processing of the uplink and downlink wireless signals is performed by the same radio gateway.

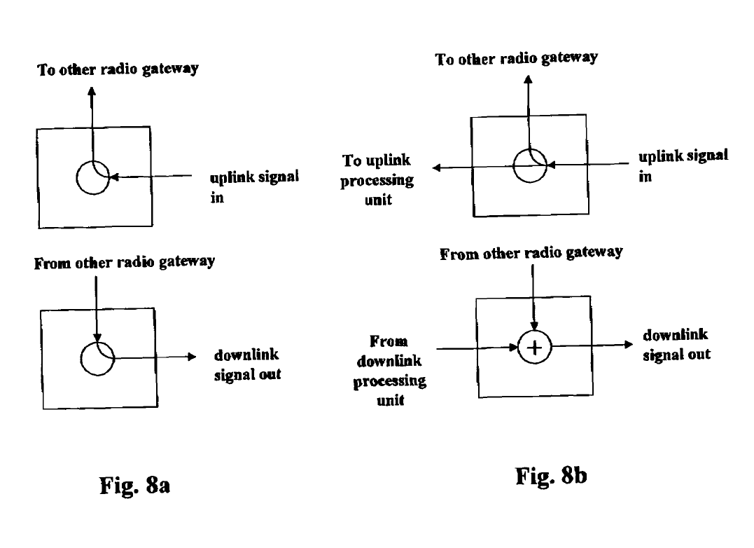

For the distributed wireless system as shown in FIG. 3, the signal distribution unit 64 in the radio gateway 23 only needs to perform the signal distribution as shown in FIG. 8a, and therefore its Irg interface is only used for transmitting uplink and downlink baseband digital wireless signals for load-sharing. As noted earlier, the routing and merging of uplink and downlink data frames are perform by the radio control and routing gateway 22, i.e., in the downlink direction, the radio control and routing gateway 22 performs separating or multicasting for the downlink data frames from the BSC/RNC according to allocation condition of channel processing resources of the radio gateways, and routes them to corresponding radio gateways; in the uplink direction, the radio control and routing gateway 22 performs merging for the uplink data frames as formed by processing from the BSC/RNC according to allocation condition of channel processing resources of the radio gateways, and transmits them to the BSC/RNC through the unified interfaces.

3. System Timing Control

In a cellular wireless communication system, each BTS has a physical channel frame timer, and therefore, all the physical channels perform transmission and reception based on such a timing. By taking a WCDMA FDD system as example, each Node B has a local frame timer (BFN) which in identical to the system frame timing (SFN) of the cells covered by it, SFN and BFN are at a range of 0-4095 frames, all the wireless channels of the cell are established with this as a reference (see protocols such as TS25.402, T825.211 and etc. for more details).

According to the present invention, it is preferable that all the radio gateways in a distributed wireless system employ the same frame timing, i.e., are completely synchronous. By taking a WCDMA system as example, there is one BFN. The maintenance of the frame timer is performed by the radio control and routing gateway 22, and the timing is distributed to the radio gateways under control through the Irc interfaces. To compensate transmission delays of interface Irg, Ira and etc., the radio control and routing gateway 22 should further estimate the transmission delay of the interface Irg, Ira and etc. through a certain delay measuring method, and perform timing control of the radio gateways through a certain control signaling.

### Second Embodiment

The second embodiment of the present invention is mostly similar to the first embodiment, and therefore the following description omits the identical portions and provides details about the difference only.

1. System Architecture

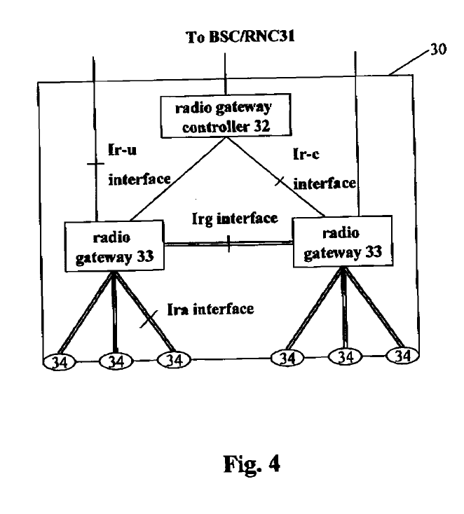

FIG. 4 shows another embodiment of the distributed wireless system with centralized control of channel processing resources according to the present invention. FIG. 4 provides an interface with the BSC/RNC, which is separated from the user plans data stream and control stream. The difference from the first embodiment of FIG. 3 is that the radio control and routing gateway is replaced by a radio gateway controller (Radio Gateway Controller—RGC) 32; radio gateways 33 directly provide user plane data flow transfer to the BSC/RNC 31 through Ir-u interfaces, and the radio gateways 33 connect to the radio gateway controller 32 through Ir-c interfaces, and the radio gateway controller 32 provides the control plane interface for connecting to the BSC/RNC 31.

In the distributed wireless system as shown in FIG. 4, the Irg interface also transmits downlink data frames of the transmission channels corresponding to the processing resources allocated for the drift radio gateway, which are transferred to the drift radio gateway via the serving radio gateway, and uplink data frames of the transmission channels corresponding to the processing resources allocated to the drift radio gateway, which are transferred to the serving radio gateway via the drift radio gateway.

The radio gateways 33 directly provide user plane data stream carrying to the BSC/RNC 31 through the Ir-u interfaces, in order to transmit uplink and downlink data frames of the transmission channels of cells belonging to the radio gateways 33. At the same time, the radio gateways 33 are connected to the radio gateway controller 32 through the Ir-c interfaces, and through the interfaces, the radio gateway controller 32 perform the following two types of control operations to its underling radio gateways 33: operations for configuration and modification of control parameters of the channel processing units within the radio gateway according to configuration state of physical channels of the underling cells, and operations including allocation control, establishment, modification, releasing and etc. of channel processing resources among the radio gateways. In addition, timing control information of the cells also needs to be transmitted through the Ir-c interfaces.

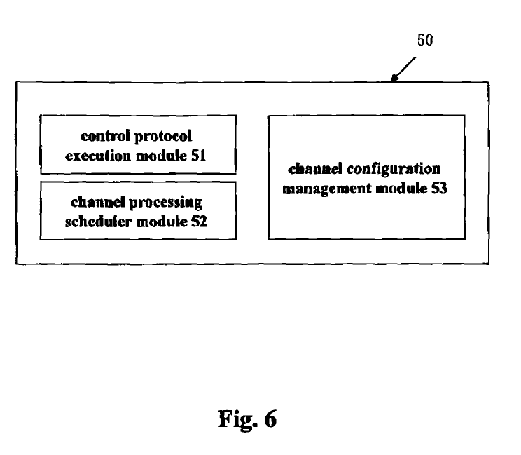

In the distributed wireless system an shown in FIG. 4, the radio gateway controller 32 mainly performs radio gateway control function. FIG. 6 shown this functional structure 50 of the radio gateway controller 32. The structure 50 comprises a control protocol execution module 51, a channel processing scheduler module 52 and a channel configuration management module 53. The control protocol execution module 51 is similar to the control protocol execution module 43 in FIG. 5, and is used for implementing a functional entity of interface control plane between the BTS and the BSC/RNC, so that the BSC/RNC may enforce control to the radio gateway through the control protocol execution module 51. Similar to the channel configuration management module 44 in figure, the channel configuration management module 53 is in charge of managing channel configuration of the radio gateways, so that the BSC/RNC may enforce control to the channel configuration of the radio gateways through the channel configuration management module 33. For example, through the channel configuration management module 53, it is possible to may the configuration and management of physical channels by the interface control plane protocol between the BTS and the BSC/RNC into operations such as configuration and modification of control parameters for channel processing units in the radio gateways. Similar to the channel processing scheduler module 45 in figure, the channel processing scheduler module 45 is in charge of overall scheduling of channel processing resources of the radio gateways which it is responsible for, i.e., implementing optimized allocation and control of the channel processing resources of the radio gateways according to actual traffic distribution of the cells, and performing operation such an establishment, modification and releasing of corresponding channel processing resources.

In the distributed wireless system as shown in FIG. 4, the radio gateway controller 32 is in charge of terminating the interface protocol of control plane between the BTS and the BSC/RNC, and provide a unified control interface with the BSC/RNC. Each radio gateway is in charge of terminating the user plane interface protocol of a respective underling cell with the BSC/RNC, and respectively provides a user data interface with the BSC/RNC. Therefore, the structure in adapted to the wireless access network employing a structure where the carrying is separated from the control. In addition, the radio gateway controller 32 is also in charge of the timing control of the entire distributed wireless system.

The structure of the radio gateways 33 is as shown in FIG. 7. The different from the first embodiment is that the Irc interface unit in the first embodiment is replaced by an Ir-c/Ir-u interface unit.

It is to be noted that, in the embodiment as shown in FIG. 6, the control protocol execution module 51 and the channel configuration management module 53 are optional. Without these two modules, it is also possible to achieve the object of the present invention.

2. Resource Control and Signal Distribution

For the distributed wireless system as shown in FIG. 4, the radio gateway 33 in the signal distribution unit 64 may perform two signal distributions as shown in distributed wireless system 8. FIG. 8a shows a case where the uplink and downlink signals of a cell are wholly switched to the drift radio gateway as required; FIG. 8b shows a case where the uplink signals of a cell are distributed at the same time to the channel processing units of the serving radio gateway and the drift radio gateway as required, thereby allowing the serving radio gateway and the drift radio gateway to respectively perform processing of a portion of uplink traffic channels in the cell's uplink signals; and the serving radio gateway and the drift radio gateway are allowed to respectively perform processing of downlink traffic channels corresponding to the uplink traffic channels in the cellos downlink signals, and the downlink signals are multiplexed into one flow of downlink signals in the signal distribution unit according to the multiplexing mode of wireless channels. FIG. 8b actually also comprises two special cases, one is that the channel processing of a cell is performed by a plurality of drift radio gateways at the same time, another is that the channel processing of a cell is performed by the serving radio gateway and a plurality of drift radio gateways at the same time.

Therefore, with respect to the distributed wireless system as shown in FIG. 4, there two kinds of data on the Irg interface, one is the uplink and downlink baseband digital wireless signals transmitted due to load-sharing, another is the downlink data frames forwarded from BSC/RNC via the serving radio gateway, and the uplink data frames returned to the serving radio gateway after the processing of the drift radio gateway. Therefore, the data stream of Irg interface has the following routing: in the downlink direction, the downlink data frames from BSC/RNC 73 are forwarded to the drift radio gateway by the serving radio gateway, so as for the drift radio gateway to generate a part or all of downlink physical channels of a designated cell and to form baseband digital signals, which are transmitted to the serving radio gateway via the Irg interface, and to synthesize down link wireless signals of the cell in the serving radio gateway, which are sent out through antenna; In the uplink direction, the uplink digital baseband signals of the cell received by the antenna are routed to the drift radio gateway via the serving radio gateway, to generate a part or all of uplink data frames after baseband processing of the drift radio gateway and to be returned to the serving radio gateway via the Irg interface, and to be finally transferred to the BSC/RNC by the serving radio gateway through the unified Ir-u interface.

3. System Timing Control

The timing control of the second is identical to that of the first embodiment.

Although the present invention has been described according to preferable embodiments, but these descriptions are only for purpose of explaining the present invention, and should not be construed as any limitation on the present invention. One skilled in the art can perform various possible modifications and improvements on the present invention, and these modifications and improvements are intended to be included in the scope and spirit of the present invention as defined by the appended claims.

1. A distributed wireless system with centralized control of resources, comprising:
a plurality of communication processing devices connected to each other, each communication processing device performing the channel processing task of cells which it is responsible for, including processing an uplink wireless signal into an uplink data frame, and processing a downlink data frame into a downlink wireless signal; and
a system control device connected to said communication processing devices and a network control device, comprising channel processing scheduling means for controlling the allocation of channel processing tasks among said communication processing devices, so that channel processing tasks of cells which one of the communication processing devices is responsible for are partly or wholly allocated to other channel processing devices for processing, and routing means for routing and transmitting data between the network control device network control device and a radio gateway.

2. The distributed wireless system of claim 1, characterized in that said system control device further comprises control protocol execution means which is used by the network control device to control the radio gateway.

3. The distributed wireless system of claim 1, characterized in that said system control device further comprises channel configuration management means which is used by the network control device to control the channel configuration of the radio gateway.

4. The distributed wireless system of claim 1, characterized in that said system control device further comprises timing control means for broadcasting system timing information to all the communication processing devices, so that the overall system is synchronous in the timing.

5. The distributed wireless system of claim 1, characterized in that said channel processing scheduling means is further configured to allocate channel processing tasks according to a predetermined condition, said predetermined condition comprises one of the following conditions: one of said communication processing devices cannot perform all the channel processing tasks of cells which it is responsible for; channel processing resource of said communication processing device fails; and channel processing load in said communication processing device reaches to a defined threshold.

6. The distributed wireless system of claim 1, characterized in that said channel processing scheduling means is further configured to allocate channel processing tasks of uplink and downlink channels corresponding to each other to the same communication processing device for execution.

7. The distributed wireless system of claim 1, characterized in that said routing means comprises user protocol execution means for transmitting user plan data between the network control device and the radio gateway.

8. The distributed wireless system of claim 1, characterized in that said routing means further comprises:
distribution means for forwarding downlink data frames corresponding to the channel processing task to be executed from the network control device to the communication processing device actually executing the channel processing tasks; and
combination means for merging uplink data frames from different communication processing devices but belonging to the same cell into one flow of uplink data frames so as to transmit to the network control device.

9. The distributed wireless system of claim 1, characterized in that said communication processing device comprises:
communication means for communicating with other communication processing devices; and
signal distribution means for transferring uplink wireless signals belonging to a channel processing task through said communication means to the communication processing device in charge of performing the channel processing task according to channel processing allocation of said channel processing scheduling means, and merging downlink wireless signals received by said communication means from different communication processing devices but belonging to a cell which it is responsible for, so an to transfer to the cell.

10. A distributed wireless system with centralized control of resources, comprising:
a plurality of communication processing devices connected to each other, each communication processing device performing the channel processing task of cells which it is responsible for, including processing an uplink wireless signal into an uplink data frame, and processing a downlink data frame into a downlink wireless signal, and directly connected to a network control device to exchange data; and
a system control device connected to said communication processing devices and the network control device, comprising channel processing scheduling means for controlling the allocation of channel processing tasks among said communication processing devices, so that channel processing tasks of cells which one of the communication processing devices is responsible for are partly or wholly allocated to other channel processing devices for processing.

11. The distributed wireless system of claim 10, characterized in that said system control device further comprises control protocol execution means which is used by the network control device to control the radio gateway.

12. The distributed wireless system of claim 10, characterized in that said system control device further comprises channel configuration management means which is used by the network control device to control the channel configuration of the radio gateway.

13. The distributed wireless system of claim 10, characterized in that said system control device further comprises timing control means for broadcasting system timing information to all the communication processing devices, so that the overall system in synchronous in the timing.

14. The distributed wireless system of claim 10, characterized in that said channel processing scheduling means is further configured to allocate channel processing tasks according to a predetermined condition, said predetermined condition comprises one of the following conditions: one of said communication processing devices cannot perform all the channel processing tasks of cells which it is responsible for; channel processing resource of said communication processing device fails; And channel processing load in said communication processing device reaches to a defined threshold.

15. The distributed wireless system of claim 10, characterized in that said channel processing scheduling means is further configured to allocate channel processing tasks of uplink and downlink channels corresponding to each other to the same communication processing device for execution.

16. The distributed wireless system of claim 10, characterized in that said communication processing device comprises:
first communication means for communicating with other communication processing devices; and
signal distribution means for transferring uplink wireless signals belonging to a channel processing task through said first communication means to the communication processing device in charge of performing the channel processing task according to channel processing allocation of said channel processing scheduling means, and merging downlink wireless signals received by said first communication means from different communication processing devices but belonging to a cell which it is responsible for, so as to transfer to the cell.

17. The distributed wireless system of claim 16, characterized in that said communication processing device comprises:
second communication means for communicating with said network control device; and
signal distribution means for merging uplink data frames from different communication processing devices but belonging to a cell which it is responsible for into one flow of uplink data frames so as to transmit to the network control device through said second communication means.
